(19) United States
(12) Patent Application Publication
(10) Pub. No.: US 2009/0139475 A1
(43) Pub. Date: Jun. 4, 2009

(54) Engine cooling system including metal foam

(75) Inventors: Stephan Donald Roozenboom, Washington, IL (US); James John Callas, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/987,516

(22) Filed: Nov. 30, 2007

(51) Int. Cl. F02F 1/02

(52) U.S. Cl. 123/41.71; 123/41.79

(57) ABSTRACT

An engine is disclosed. The engine has an engine block and a cylinder within the engine block. The engine also has a cylinder head associated with a portion of the engine block and the cylinder. The engine further has a plurality of coolant passages formed within the engine block and the cylinder head, wherein a portion of the plurality of coolant passages is filled with a metal foam.

### TECHNICAL FIELD

This disclosure relates generally to an engine cooling system and, more particularly, to an engine coolant system having metal foam.

### BACKGROUND

Machines such as, for example, passenger vehicles and generators, include engine components that are exposed to high temperatures during operation. These high temperatures may cause excessive thermal stresses within engine components, which may lead to structural failure of the components. Engine systems utilize heat transfer to reduce engine temperature, helping to prevent this type of failure. For example, engine blocks typically contain internal coolant passages capable of passing coolant throughout the engine structure. As the coolant flows through the engine block, the coolant absorbs heat from the engine components. The heated coolant flows out of the engine and into a heat exchanger (e.g., a radiator), where heat transfers from the coolant to ambient air. The cooled coolant then passes back into the coolant passages of the engine, allowing the cycle of heat transfer to continue.

This scheme of heat transfer may adversely affect the structural integrity of the engine block. Since the coolant passages create unsupported voids within the engine block, the structural capacity of the engine is reduced. In addition, uneven distribution of temperatures may occur adjacent to coolant passages when an engine is operating. Certain parts of an engine tend to become hotter than other parts. Coolant flowing through hollow passages may not change this uneven distribution of heat into a uniform temperature across the engine.

U.S. Pat. No. 6,223,702 (the '702 patent) issued to Achenbach et al. on May 1, 2001, discloses a system for cooling an engine. The system described by the '702 patent includes an engine block having open coolant passages. The '702 patent also describes a coolant jacket consisting of a metal foam, having a lower specific weight than that of typical casting materials.

Although the system of the '702 patent may provide a lightweight coolant jacket composed of metal foam, it fails to provide a technique for increasing the structural integrity of the engine at unsupported voids caused by coolant passages. Also, the system of the '702 patent fails to change the uneven distribution of temperatures in an operating engine into a uniform distribution of temperatures.

The present disclosure is directed to improvements in the existing technology.

### SUMMARY OF THE DISCLOSURE

In accordance with one aspect, the present disclosure is directed toward an engine. The engine includes an engine block and a cylinder within the engine block. The engine also includes a cylinder head associated with a portion of the engine block and the cylinder. The engine further includes a plurality of coolant passages formed within the engine block and the cylinder head, wherein a portion of the plurality of coolant passages is filled with a metal foam.

According to another aspect, the present disclosure is directed toward a method for cooling an engine. The method includes providing coolant passages through the engine and filling a portion of the coolant passages with a metal foam.

### BRIEF DESCRIPTION OF THE DRAWINGS

FIG. 1 is a diagrammatic illustration of an exemplary disclosed engine; and

FIG. 2 is a cross-section of the engine of FIG. 1, taken along line A-A.

### DETAILED DESCRIPTION

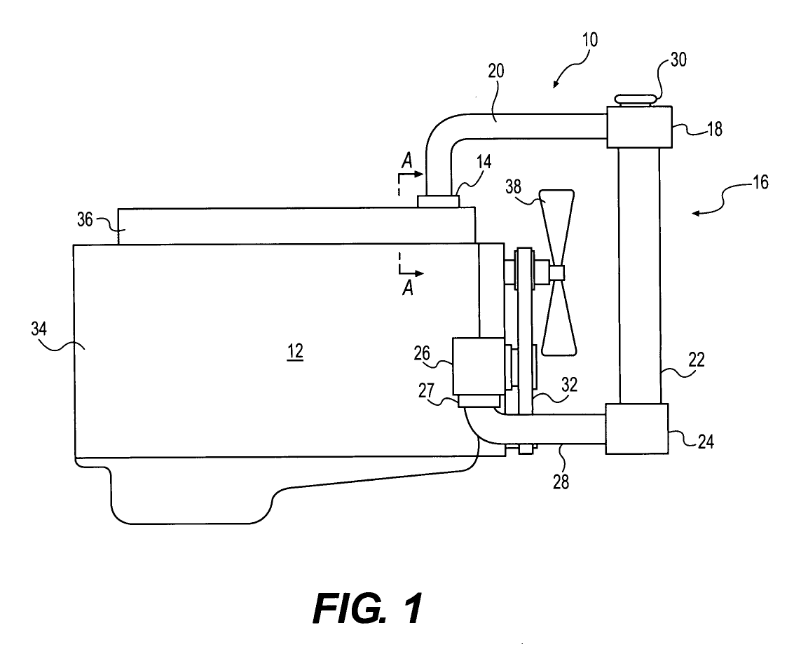

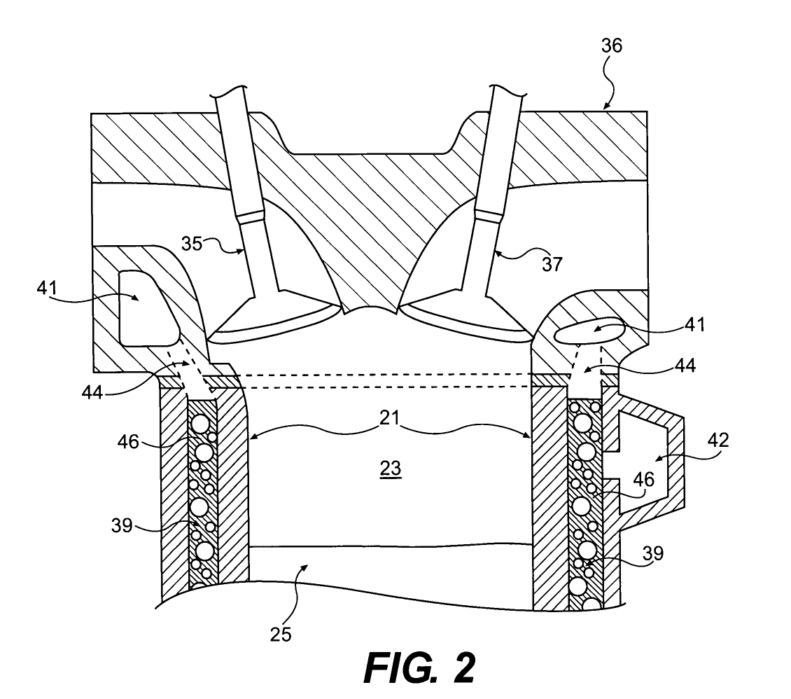

FIG. 1 illustrates an exemplary disclosed engine 12 that may produce a mechanical power output. Engine 12 may be an internal combustion engine such as, for example, a diesel engine, a gasoline engine, a gaseous fuel-powered engine, or any other type of engine apparent to one skilled in the art. Engine 12 may include an engine block 34 that at least partially defines a plurality of cylinders 21 (only one shown in FIG. 2). Engine 12 may also include a piston 25 (shown in FIG. 2) slidably disposed within each cylinder 21, and a crankshaft (not shown) that is rotatably supported within engine block 34 by way of a plurality of journal bearings (not shown). A connecting rod (not shown) may connect each piston 25 to the crankshaft so that a sliding motion of pistons 25 within each respective cylinder 21 results in a rotation of the crankshaft. A cylinder head 36 may be attached to a top of engine block 34, so that a combustion chamber 23 (shown in FIG. 2) may be formed between a bottom of cylinder head 36, interior walls of cylinder 21, and a top or crown of piston 25. Cylinder head 36 may house additional engine components such as, for example, one or more intake valves 35 and one or more exhaust valves 37 (one of each shown in FIG. 2).

During its operation, engine 12 may produce heat from the combustion of fuel and air within cylinder 21. To dissipate this heat, engine 12 may include a cooling system 10. Cooling system 10 may help absorb the heat from engine 12 by directing a coolant through engine 12, and then dissipating this heat to the surrounding environment via a heat exchanger or radiator 16. Radiator 16 may include a top tank 18, a core 22, and a bottom tank 24. Top tank 18 may serve to receive the coolant, which may be any suitable coolant known in the art such as, for example, a mixture of water and ethylene glycol (i.e., antifreeze). Top tank 18 may include a filling neck 30 that may provide an opening for coolant to be added to cooling system 10. Filling neck 30 may include a cap.

Top tank 18 may be fluidly connected to core 22. Core 22 may operate to expel heat from cooling system 10 as coolant flows through core 22. Core 22 may be made from any suitable material known in the art, including aluminum or copper. Core 22 may include numerous flattened tubes (not shown) configured in a parallel arrangement, through which coolant may flow. As the coolant comes into contact with the interior surface of the tubes, heat may be released from the coolant into the tubes and, subsequently, to ambient air or another heat-transferring medium. Each tube may include obstructions that make the coolant flow turbulent, causing more volume of the coolant to touch the interior surface of the tubes and increase the rate of heat transfer. Core 22 may work in conjunction with a fan 38, which may be driven directly or indirectly by engine 12. In one embodiment, fan 38 may blow or draw ambient air across core 22, which may further increase the rate of heat transfer from the coolant flowing through the tubes to the ambient air.

Core 22 may be fluidly connected to bottom tank 24. Bottom tank 24 may be fluidly connected to a pump 26 by way of a pipe or hose 28. Pump 26 may be mounted to engine 12 and driven by engine 12 via a fan belt 32. Pump 26 may be an impeller type pump including a shaft (not shown) that is rotated by fan belt 32. The shaft may be connected to an impeller, where fan belt 32 causes both the shaft and impeller to rotate within a housing. The impeller may include curved blades that pressurize and push fluid as the impeller rotates, thereby pumping coolant through cooling system 10. Cooling system 10 may additionally include a coolant filter 27, which may be fluidly connected between hose 28 and pump 26. Coolant filter 27 may include a filter medium, serving to filter out rust and other debris from coolant flow and helping to prevent clogging of the coolant flow through cooling system 10.

As shown in FIG. 2, cooling system 10 may also include a storage passage 42, which may fluidly connect pump 26 to coolant passages 39 and may serve to store coolant prior to entering coolant passages 39. Coolant passages 39 may be located within engine block 34, adjacent to cylinders 21, and may serve to allow coolant flow to dissipate heat from cylinders 21. Cooling system 10 may also include coolant passages 44 that may serve to fluidly connect coolant passage 39 to coolant passages 41. Coolant passages 41 may be located within cylinder head 36 and may serve to allow coolant flow to dissipate heat from cylinder head 36.

Coolant passages 39, 41, and 44, as well as other coolant passages (not shown) in engine 12, may contain metal foam 46 (shown in FIG. 2). Metal foam 46 may embody a network of connected ligatures composed of a metal such as, for example, copper, aluminum, silver, gold, nickel, or any other suitable metal known in the art. Metal foam 46 may be formed with an open cell structure or a combination of an open cell and closed cell structure. The percentage of void space in metal foam 46 (i.e., the percentage of space not occupied by metal material) may be modified to adjust properties such as porosity for controlling flow rate and/or metal foam surface area for influencing heat transfer rate. For example, if greater flow rate is desired, the percentage of void space in metal foam 46 may be increased, effectively increasing the porosity of metal foam 46. As an additional example, if greater heat transfer is desired, the surface area of ligatures may be increased, effectively increasing the rate of heat transfer from metal foam 46 to the passing coolant. In addition to influencing heat transfer qualities and porosity, the metal ligatures of metal foam 46 may also serve as structural members within coolant passages 39, 41, and 44, increasing the overall structural capacity of engine 12.

Metal foam 46 may be formed with a uniform percentage of void space (void space being dependent on the number and size of metal ligatures per unit volume) or alternatively with a gradient of void space. For example, metal foam 46 may be formed with a lower percentage of void space at a radially inner location (i.e., near the centers of coolant passages 39, 41, and 44) and/or at a radially outer location (i.e., near the walls of coolant passages 39, 41, and 44). Varying void space may effectively control the flow of coolant through passages 39, 41, and 44.

Metal foam 46 may be cast within coolant passages 39, 41, and 44 during the manufacturing of engine 12. It is contemplated that metal foam 46 may be bonded to the walls of coolant passages 39, 41, and 44 using a brazing process and a brazing material. The brazing material may be composed of, for example, silver, copper, tin, magnesium, aluminum-silicon, and/or other suitable materials known in the art.

Metal foam 46 may be cast either in all or only select locations of coolant passages 39, 41, and 44, based on the requirements of engine 12. For example, the heat transfer qualities of metal foam 46 may be concentrated at locations within engine 12 that are susceptible to high temperatures and thermal stresses (i.e. providing metal foam 46 with greater surface area). By increasing heat transfer within coolant passages near parts of engine 12 that are particularly susceptible to heat, metal foam 46 may serve to create a uniform temperature within engine 12, which may be beneficial to the operation of engine 12. As another example, the structural capacity of metal foam 46 may be increased at locations within engine 12 that are susceptible to structural failure. By providing metal foam 46 with a greater concentration of ligatures at certain locations, the capacity of structurally vulnerable areas of engine 12 may be selectively reinforced.

Coolant passages 41 may be fluidly connected to a thermostat assembly 14, located adjacent to cylinder head 36. Thermostat assembly 14 may include a thermally sensitive element (not shown) configured to restrict and allow coolant flow based on a temperature of coolant. Thermostat assembly 14 may serve to selectively block the flow of coolant from engine block 34 and cylinder head 36 to or from top tank 18 when the temperature of the engine is too low, and to allow the flow of coolant when the temperature of the engine exceeds a given threshold. Thermostat assembly 14 may be fluidly connected to a hose 20, allowing coolant from coolant passages 39 to flow to or from top tank 18.

### INDUSTRIAL APPLICABILITY

The disclosed cooling system may help to provide a technique for increasing the structural integrity of the engine at unsupported voids caused by coolant passages. Also, the disclosed cooling system may change the uneven distribution of temperatures in an operating engine into a uniform distribution of temperatures, which may be favorable for engine operation.

An operator may start engine 12, actuating fan belt 32 and causing pump 26 and fan 38 to begin operation. Pump 26 may pressurize a flow of chilled coolant into storage passage 42. Coolant may flow from storage passage 42 into coolant passages 39, 41, and 44 within engine 12. Engine components, such as cylinder 21 and cylinder head 36, may be heated by the combustion process of engine 12. Heat may be dissipated from these engine components to the chilled coolant located in coolant passages 39, 41, and 44. The rate of heat transfer may be higher within areas of coolant passages 39, 41, and 44 containing metal foam 46. Additionally, the rate of flow of coolant through metal foam 46 may be altered due to the arrangement of ligatures of metal foam 46.

Once the coolant within engine 12 becomes heated, thermostat assembly 14 may open to coolant flow. The heated coolant may then flow into hose 20. Pump 26 may pump the heated coolant through top tank 18 and into core 22 of radiator 16. Fan 38 may blow or draw ambient air across core 22, causing heat to be dissipated from the coolant to the air and effectively reducing the temperature of the coolant.

Pump 26 may force the cooled coolant into bottom tank 24 and through hose 28. The chilled coolant may be drawn from hose 28 and into coolant filter 27, where debris located in the coolant flow may be removed. The chilled coolant may be drawn into pump 26, completing a loop of flow through cooling system 10. Pump 26 may again pressurize the chilled coolant into passages 39, 41, 42, and 44 to dissipate heat from engine 12, allowing the cycle of cooling system 10 to continue.

Metal foam 46 of cooling system 10 may help to provide a technique for increasing the structural integrity of engine 12 at unsupported voids caused by coolant passages 39, 41, and 44. The ligatures of metal foam 46 may act as structural members within the voids, improving the overall structural integrity of engine 12. Also, metal foam 46 may be concentrated in areas of engine 12 susceptible to high temperatures, increasing the rate of heat transfer at these locations, which may contribute to an overall uniform temperature distribution within engine 12 that may be favorable for engine operation.

It will be apparent to those skilled in the art that various modifications and variations can be made to the disclosed cooling system. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. An engine, comprising:
an engine block;
a cylinder within the engine block;
a cylinder head associated with a portion of the engine block and the cylinder; and
a plurality of coolant passages formed within the engine block and the cylinder head, wherein a portion of the plurality of coolant passages is filled with a metal foam.

2. The engine of claim 1, wherein the metal foam includes a plurality of connected ligatures, wherein the ligatures provide structural integrity to the coolant passages.

3. The engine of claim 2, wherein the metal foam is concentrated in a plurality of locations within the engine that are susceptible to structural weakness.

4. The engine of claim 1, wherein the metal foam is made from copper, aluminum, silver, gold, or nickel.

5. The engine of claim 1, wherein the metal foam is an open cell structure.

6. The engine of claim 1, wherein the metal foam is a combination of an open cell structure and a closed cell structure.

7. The engine of claim 1, wherein the metal foam is formed with a uniform percentage of void space.

8. The engine of claim 1, wherein the metal foam is formed with a gradient of void space.

9. The engine of claim 1, wherein the metal foam is cast inside of the coolant passages using a brazing process and a brazing material.

10. The engine of claim 9, wherein the brazing material includes silver, copper, tin, magnesium, or aluminum-silicon.

11. The engine of claim 1, wherein the metal foam is concentrated in a plurality of locations within the engine that are susceptible to high temperatures.

12. The engine of claim 11, wherein a surface area of the metal foam is increased in the plurality of locations that are susceptible to high temperatures.

13. A method for cooling an engine, comprising:
providing coolant passages through the engine; and
filling a portion of the coolant passages with a metal foam.

14. The method of claim 13, further including concentrating the metal foam in locations within the engine that are susceptible to structural weakness.

15. The method of claim 13, wherein the metal foam is made from copper, aluminum, silver, gold, or nickel.

16. The method of claim 13, further including forming the metal foam with a gradient of void space.

17. The method of claim 13, further including bonding the metal foam inside of the passages using a brazing process and a brazing material.

18. The method of claim 13, further including concentrating the metal foam in a plurality of locations within the engine that are susceptible to high temperatures.

19. The method of claim 18, further including concentrating a surface area of the metal foam in the plurality of locations that are susceptible to high temperatures.

20. An engine cooling system, comprising:
a storage tank for storing a coolant;
a heat exchanger fluidly connected to the storage tank;
a pump fluidly connected to the heat exchanger; and
an engine fluidly connected to the pump, the engine including:
an engine block;
a cylinder within the engine block;
a cylinder head associated with a portion of the engine block and the cylinder; and
a plurality of coolant passages formed within the engine block and the cylinder head, wherein a portion of the plurality of coolant passages is filled with a metal foam.

21. A method for operating an engine, comprising:
providing a coolant to the engine; and
passing the coolant through a plurality of passages within the engine, wherein a portion of the passages is filled with a metal foam.

22. The method of claim 21, wherein the metal foam is concentrated in a plurality of locations within the engine that are susceptible to structural weakness.

23. The method of claim 21, wherein the metal foam is made from copper, aluminum, silver, gold, or nickel.

24. The method of claim 21, wherein the metal foam is concentrated in a plurality of locations within the engine that are susceptible to high temperatures.
